(19) United States
(12) Patent Application Publication
(10) Pub. No.: US 2022/0227199 A1
(43) Pub. Date: Jul. 21, 2022

(54) Truck Bed With Integrated Heating System

(71) Applicant: Toyota Motor Engineering & Manufacturing North America, Inc., Plano, TX (US)

(72) Inventors: Ryan C. Harris, Saline, MI (US); Scott L. Frederick, Brighton, MI (US)

(73) Assignee: Toyota Motor Engineering & Manufacturing North America, Inc., Plano, TX (US)

(21) Appl. No.: 17/153,153

(22) Filed: Jan. 20, 2021

(51) Int. Cl. B60H 1/00; E04H 15/06

(52) U.S. Cl. CPC B60H 1/00271; E04H 15/06

(57) ABSTRACT

A pickup truck includes a passenger cabin and a truck bed located rearward of the passenger cabin in a vehicle longitudinal direction. The truck bed includes a bed deck and a pair of spaced apart sidewalls. A heating system includes a heating unit located between an inner sidewall panel and an outer sidewall panel of one of the sidewalls. The heating unit is in communication with an outlet the extends through the inner sidewall panel.

### TECHNICAL FIELD

The present specification generally relates to pickup trucks and, more specifically, to pickup trucks with truck beds that include integrated heating systems.

### BACKGROUND

Vehicle camping including truck bed and rooftop tents are becoming increasingly popular. This is due, at least in part, to improved convenience and ease of setup and take down. One issue with tent camping is heating outside during cold conditions. It is common for a user to start the vehicle and sit inside using the vehicle's heater unit for heat. However, the user must leave their tent and start the vehicle. What is needed is a truck bed that includes an integrated heating system that can be used to provide heat outside the cabin of the vehicle.

### SUMMARY

In accordance with one embodiment, a pickup truck includes a passenger cabin and a truck bed located rearward of the passenger cabin in a vehicle longitudinal direction. The truck bed includes a bed deck and a pair of spaced apart sidewalls. A heating system includes a heating unit located between an inner sidewall panel and an outer sidewall panel of one of the sidewalls. The heating unit is in communication with an outlet the extends through the inner sidewall panel.

In accordance with another embodiment, a method of forming a heating system for a pickup truck that is exterior of a passenger cabin of the pickup truck. The method includes placing a heating unit between an inner sidewall panel and an outer sidewall panel of a truck bed of the pickup truck. The heating unit is fluidly connected to an outlet through the inner sidewall panel.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following description of the illustrative embodiments can be understood when read in conjunction with the following drawings, where like structure is indicated with like reference numerals and in which:

FIG. 1 diagrammatically depicts a side view of a pickup truck having a truck bed with a truck bed cover, according to one or more embodiments shown and described herein;

FIG. 2 diagrammatically depicts a truck bed of the pickup truck of FIG. 1, according to one or more embodiments shown and described herein; and

FIG. 3 diagrammatically depicts a section view along line 3-3 of FIG. 2 showing a heating system inside a sidewall of the truck bed, according to one or more embodiments shown and described herein.

### DETAILED DESCRIPTION

Pickup trucks according to the present specification include a passenger cabin and a truck bed located rearward of the passenger cabin. The truck bed includes opposite sidewalls and a bed deck that extends between the sidewalls. The sidewalls are formed by an outer sidewall panel and an inner sidewall panel. At least one of the sidewalls includes a heating system that is located between the respective outer sidewall panel and inner sidewall panel. The heating system may include a heating unit and a blower that is fluidly connected to an outlet in the inner sidewall panel. The outlet may include a connector that can be used to connect to a flexible duct. The flexible duct may be used to direct heated air to a location exterior of the passenger cabin.

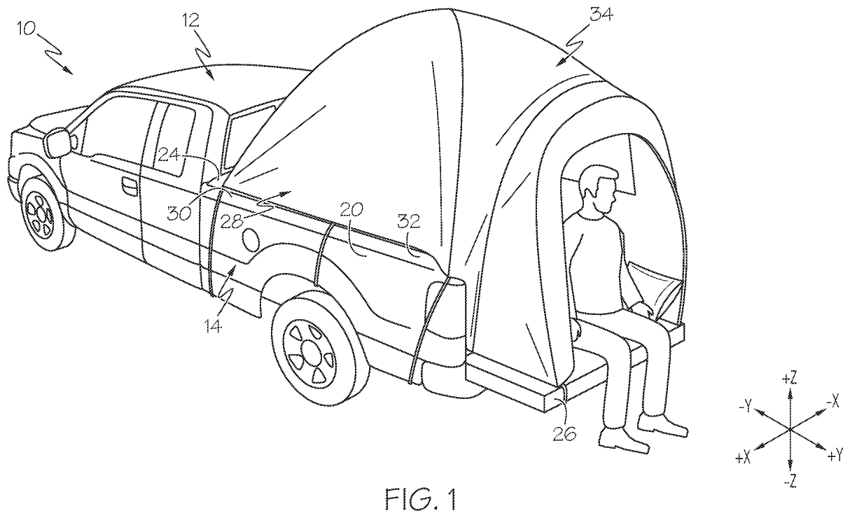

As used herein, the term “vehicle longitudinal direction” refers to the forward-rearward direction of the pickup truck (i.e., in the +/− vehicle Y direction depicted in FIG. 1). The term “vehicle lateral direction” refers to the cross-pickup truck direction (i.e., in the +/− vehicle X direction depicted in FIG. 1), and is transverse to the vehicle longitudinal direction. The term “vehicle vertical direction” refers to the upward-downward direction of the pickup truck (i.e., in the +/− vehicle Z-direction depicted in FIG. 1). As used herein, “upper” and “above” are defined as the positive Z direction of the coordinate axis shown in the drawings. “Lower” and “below” are defined as the negative Z direction of the coordinate axis shown in the drawings.

Referring to FIG. 1, the terms “outboard” or “outward” as used herein refers to the relative location of a component in a direction with respect to a pickup truck centerline. The term “inboard” or “inward” as used herein refers to the relative location of a component in a direction with respect to the pickup truck centerline. Because the pickup truck structures may be generally symmetrical about the pickup truck centerline, the direction to which use of terms “inboard,” “inward,” “outboard” and “outward” refer may be mirrored about the pickup truck centerline when evaluating components positioned along opposite sides of the pickup truck 10.

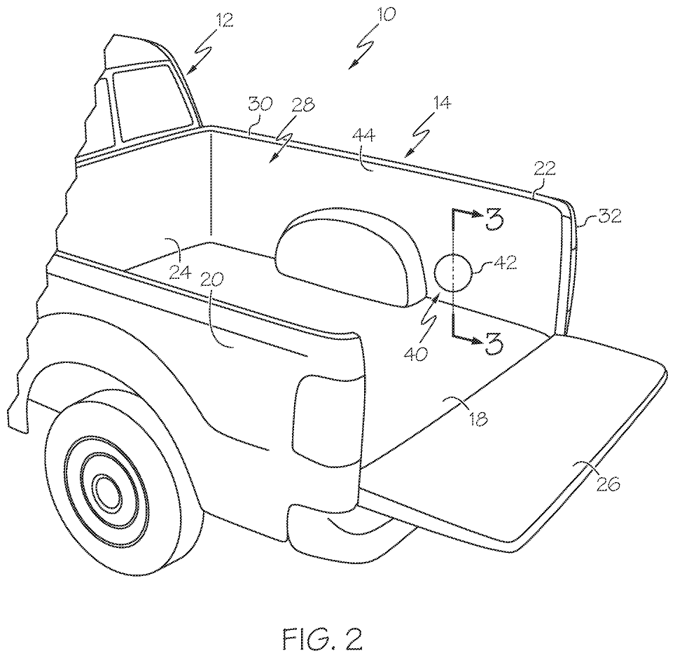

Referring to FIGS. 1 and 2, a pickup truck is generally illustrated at 10. The pickup truck 10 includes a passenger cabin 12 and a truck bed 14. The truck bed 14 includes a bed deck 18, a pair of spaced apart sidewalls 20, 22, a front wall 24, and a tailgate 26. The bed deck 18, the sidewalls 20, 22, the front wall 24, and the tailgate 26 define a storage area 28 of the truck bed 14.

The sidewalls 20, 22 extend parallel to the vehicle longitudinal direction. Each sidewall 20, 22 includes a front end 30 and an opposite rear end 32. The front wall 24 extends between the front ends 30 of the sidewalls 20, 22. The tailgate 26 extends between the rear ends 32 of the sidewalls 20, 22.

The tailgate 26 is pivotally connected to the sidewalls 20, 22 for movement between a closed position and an open position. In the closed position, the tailgate 26 extends parallel to the vehicle vertical direction. In the open position, the tailgate 26 extends parallel to the vehicle longitudinal direction as shown in FIGS. 1 and 2.

FIG. 1 illustrates a truck bed tent 34 that is located in the truck bed 14. The truck bed tent 34 may be wholly within the truck bed 14 as shown, or only partially within the truck bed 14. In some embodiments a ground tent or other enclosure, such as an ice fishing shelter, blind, rooftop tent of another vehicle, etc. may be located wholly outside the truck bed.

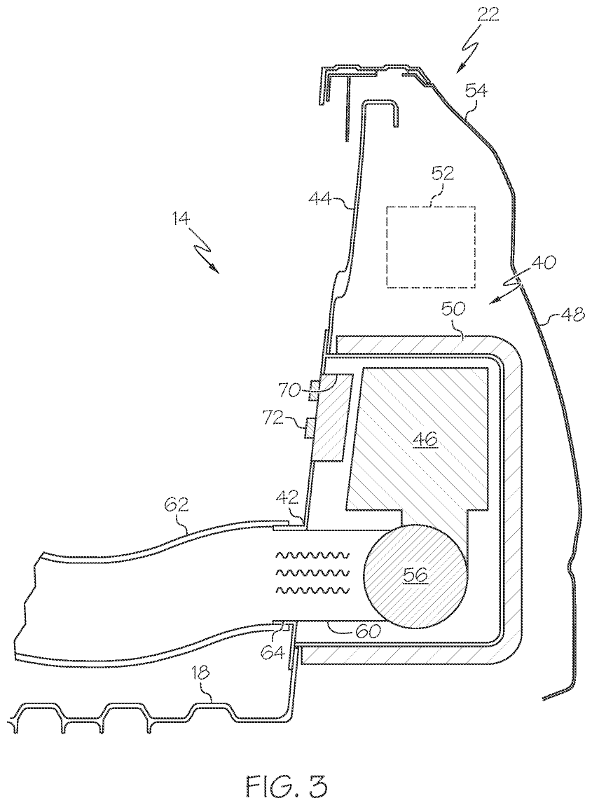

Referring to FIG. 2, inside the sidewall 22 is a heating system 40 that is connected to an outlet 42 that extends through an inner sidewall panel 44 of the sidewall 22. Referring now to FIG. 3, the heating system 40 includes a heating unit 46 that is located between the inner sidewall panel 44 and an outer sidewall panel 48 of the sidewall 22 such that the heating unit 46 is not visible from outside the truck 10. The heating unit 46 is fixedly mounted within the sidewall 22 at a location that is spaced from the inner sidewall panel 44 and the outer sidewall panel 48. In some embodiments, the heating unit 46 may be at least partially enclosed by a heat shield 50. As used herein, a “heat shield” refers to a structure that is effective in reducing one or more of convective, conductive and radiative heat transfer from the heating unit 46 to one or both of the inner sidewall panel 44 and the outer sidewall panel 48. The heat shield 50 can be formed of any suitable material, such as stainless steel, ceramic, foam, etc. Spacing the heating unit 46 from both the inner sidewall panel 44 and the outer sidewall panel 48 can also reduce heat transfer to the panels 44 and 48. The heating unit 46 may be any suitable type, such as electric resistance, butane, propane or any other type of heating system. In some embodiments, the heating unit 46 may be wired directly to the truck 10 so that there is no need for separate batteries or other power source. If a fuel is used, a compartment 52 may be provided inside the sidewall 22 so as not to be visible. A panel, represented by element 54, may be provided that can be opened to access the compartment 52 and replace the fuel.

The heating unit 46 may be connected to a blower 56. The blower 56 may be part of the heating unit 46 or be a separate component that is operatively connected to the heating unit 46. The blower 56 may include a fan that is used to push heated air from the heating unit 46 to the outlet 42 that is formed in the inner sidewall panel 44. To this end, an interior duct 60 may connect the blower 56 to the inner sidewall panel 44 at the outlet 42.

An exterior duct 62 may be removably connected to a connector 64 at the outlet 58. The exterior duct 62 may be flexible so that an end of the flexible duct can be placed at a desired location (e.g., within the truck bed tent 34). The exterior duct may have any suitable length. A longer exterior duct 62 can allow the end of the exterior duct 62 to be moved outside of the truck bed 14 and into an enclosure on the ground or even on another vehicle. For example, the exterior duct 62 may be placed in or near a rooftop tent of another vehicle for heating the rooftop tent. The exterior duct 62 may be removed from the connector 64 to blow heat directly out of the outlet 58 if desired.

A control unit 70 may be located at the heating system 40. For example, the control unit 70 may be mounted in the inner sidewall panel 44. The control unit 70 may include buttons, knobs, or other controls 72 that can be used to adjust heating conditions, such as ON/OFF, temperature, fan speed, etc. The control unit 70 may have a display that displays the heating conditions. In some embodiments, the heating system 40 may be connected to a vehicle electronic control unit (ECU). In some embodiments, the heating system 40 may be controlled wirelessly, such as using a smartphone or other device. Temperature sensors, wired and/or wireless, can be used to shut off the heating system 40 automatically.

The above-described pickup trucks include a heating system that is located within a sidewall of the truck bed and is separate from the tuck HVAC unit. The heating system includes a flexible duct that can be used to direct heated air to a desired location, even outside of the truck bed. The heating system can be controlled using controls mounted on the sidewall of the truck bed. In some embodiments, the heating system may be controlled wirelessly using a smartphone or other computing device.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A pickup truck comprising:
a passenger cabin;
a truck bed located rearward of the passenger cabin in a vehicle longitudinal direction, the truck bed includes a bed deck and a pair of spaced apart sidewalls; and
a heating system comprising a heating unit located between an inner sidewall panel and an outer sidewall panel of one of the sidewalls, the heating unit in communication with an outlet the extends through the inner sidewall panel.

2. The pickup truck of claim 1, wherein the heating system comprises a blower that blows heated air through the outlet.

3. The pickup truck of claim 2, wherein an interior duct connects the blower to the outlet.

4. The pickup truck of claim 2, wherein the heating system comprises an exterior duct that connects to the outlet to direct heated air away from the outlet.

5. The pickup truck of claim 1, wherein the heating system comprises a heat shield that at least partially encloses the heating unit.

6. The pickup truck of claim 1, wherein the heating unit is spaced from both the inner sidewall panel and the outer sidewall panel of the one of the sidewalls.

7. The pickup truck of claim 1 further comprising a control unit that controls operation of the heating unit.

8. The pickup truck of claim 7, wherein the control unit is mounted in the inner sidewall panel.

9. A method of forming a heating system for a pickup truck that is exterior of a passenger cabin of the pickup truck, the method comprising:
placing a heating unit between an inner sidewall panel and an outer sidewall panel of a truck bed of the pickup truck; and
fluidly connecting the heating unit to an outlet through the inner sidewall panel.

10. The method of claim 9 further comprising blowing heated air toward the outlet using a blower.

11. The method of claim 10 further comprising connecting the blower to the outlet using an interior duct.

12. The method of claim 10 directing heated air away from the outlet using an exterior duct that connected to the outlet.

13. The method of claim 9 further comprising at least partially enclosing the heating unit with a heat shield.

14. The method of claim 9 further comprising spacing the heating unit from both the inner sidewall panel and the outer sidewall panel of the one of the sidewalls.

15. The method of claim 9 further comprising providing a control unit that controls operation of the heating unit.

16. The method of claim 15 further comprising mounting the control unit in the inner sidewall panel.
